(19) United States
(12) Patent Application Publication
(10) Pub. No.: US 2026/0131498 A1
(43) Pub. Date: May 14, 2026

(54) Process and Design Modifications to Retrofit a Conventional Wood Plant

(71) Applicant: T2Earth Holdings, LLC, Woodbury, NY (US)

(72) Inventors: Joel Kier, New York, NY (US); Roland Fritsch, Evans, GA (US); Levi Anderson Pollard, V, Appling, GA (US)

(21) Appl. No.: 19/442,540

(22) Filed: Jan. 7, 2026

Related U.S. Application Data
(63) Continuation-in-part of application No. 18/210,448, filed on Jun. 15, 2023, now abandoned.
(60) Provisional application No. 63/352,899, filed on Jun. 16, 2022.

(51) Int. Cl. B27K 3/10; B27K 3/02

(52) U.S. Cl. CPC B27K 3/10; B27K 3/025

(57) ABSTRACT

A transformation of an existing, conventional southern yellow pine (SYP) lumber pressure treatment plant that previously impregnated wood with non-sustainable chemicals, to using environmentally friendly sodium silicate formulations. The transformation may include adding heated storage tanks for solutions of siliceous solutions and adding a heater to an existing storage tank, installing delivery lines capable of handling high pH, viscous solutions between at least the pre-existing vacuum pressure impregnation tank and the added or existing heated storage tank, a CO₂ storage tank with associated vaporizer and a CO₂ recovery system, associated lines to and from the pre-existing vacuum pressure impregnation tank and the CO₂ storage tank and the CO₂ recovery system, pumps for circulating the solutions, and a thermal management system including: insulation and cladding on one or more of the tanks and lines, heat tracing on all level indicators; and insertion of heating coils in working tanks.

### CROSS REFERENCE

This is a continuation-in-part of U.S. application Ser. No. 18/210,448 filed Jun. 15, 2023, which claims priority on Application No. 63/352,899 filed Jun. 16, 2022, the content of which are incorporated herein by reference.

### FIELD OF THE INVENTION

This present disclosure relates to transforming an existing, conventional southern pine (SYP) wood pressure treatment plant that previously impregnated wood with non-sustainable chemicals, such as CA (copper azole), CCA (chromated copper arsenate), and ACQ (alkaline copper quaternary) into a plant to treat wood with environmentally friendly sodium silicate formulations or other sustainable formulations. The sodium silicate is a colloidal solution with shear thickening behavior, unlike the non-sustainable treatments. Wood means dimensional lumber, plywood, engineered wood such as LVL (laminated veneer lumber), OSB (oriented strand board) and mass timber, including CLT (cross laminated timber), and related products.

### DISCUSSION OF RELATED ART

Wood is one of the oldest building materials used in human civilization due to its strength, availability, and performance characteristics. Despite these characteristics, wood suffers if exposed to prolonged wet conditions and due to its poor resistance to insect, fungal, and other biological attacks. As a result of this susceptibility, treatments are applied to wood to improve its durability to insects, fire retardancy, and environmental conditions. These treatments have traditionally been in the form of metal or other environmentally unfriendly chemicals, such as CA (copper azole), CCA (chromated copper arsenate), and ACQ (alkaline copper quaternary), and in the case of fire retardancy enhancements, OPFR (organophosphorus flame retardants), and chemicals such as.

The treatment of wood with metal silicate is known. DeTraube teaches the use of vacuum pressure impregnation to apply sodium silicate to wood. However, the properties of shear thickening colloidal suspensions are not taken into account in either the formulation development or in the processing

FIG. 1 shows a traditional lumber pressure treatment plant used in a traditional treatment process. The traditional wood pressure treatment plant impregnates wood using non-sustainable chemicals. The plant comprises a forest product receiving area 101 where the lumber and plywood is received. Preferably, the lumber, plywood, or related forest products is received in standard dimensional lumber size and no further milling or sawing is required. Alternatively, there is a subsequent milling or sawing step after the lumber or plywood is received. A first processing occurs at a vacuum pressure impregnation vessel 102. Impregnation vessel 102 is also commonly referred to as a reactor or autoclave. After the vacuum pressure impregnation, the lumber is moved to a storage and acclimation area 103. The next area is a stick insertion area 104, where sticks are inserted in between layers of the different forest products. The next area is a kiln 105 where the lumber is dried. After the lumber is dried, the lumber is moved to a tilt hoist where the sticks are removed 106 A tilt hoist is a device for lifting wood by tilting the stack and lifting it. The lumber then is labeled and packaged at a label and packaging station 107 and sent to a storage area 108 for storage and shipping.

Plywood is processed in a similar manner in which plywood panels in bundles would flow on conveyors or moved by forklifts to an autoclave. After processing in the autoclave, the plywood is transferred to a drying kiln, and then to labeling, packaging, and shipping.

### SUMMARY OF THE DISCLOSURE

The process of impregnating non-sustainable chemicals such as chromated copper arsenate is a standard practice in the wood industry. The chemical formulations are fluids that are low in viscosity and are typically identified as Newtonian fluids. These are fluids that do not change in viscosity when stress or pressure is applied. Due to this Newtonian behavior, conventional treating solutions are readily absorbed into the wood and, as such, the manufacturing process used for them requires a less demanding application process than the process applications describe below for sodium silicate ((Na₂O)x·SiO₂) and related metal silicate based solutions. Thus, to adjust an existing wood processing plant reactor to the demands of sodium silicate solutions that are considered shear thickening fluids requires processing equipment that can handle a polar, caustic, aqueous solution that possesses some non-Newtonian characteristics to impregnate the wood.

A shear thickening fluid becomes more viscous or stiffer as pressure is applied one must use caution to not use too high a pressure or flow will be prevented thus these fluids require unique formulation specificity as in taught in Berg, et al in US 20210170623A1 to accommodate for this characteristic. The shear thickening behavior is due to the silicate solution not being a true solution, but rather a colloidal solution of suspended particles that are capable of interaction at high shear rates. Such high shear rates occur when the silicate solution is forced through the small apertures in a wooden article under vacuum pressure impregnation process commonly used to impregnate wood.

Processing modifications are required to reproducibly impregnate a wooden article and due to the dominant use of vacuum pressure impregnation (VPI) to treat wood. A manufacturing facility designed to treat wood will require modifications, as the prior art solutions used to impregnate wood are true solutions that are neither colloidal nor shear thickening.

One aspect of the disclosure includes the modifications that are necessary to retrofit an existing treatment plant to accommodate the changes for effective and reproducible treatment of wood products. Since processes and equipment needed to treat wood with shear thickening materials beyond a surface coating level are not used in VPI treatment of wood, one aspect of the disclosure addresses the manner in which this impregnation is accomplished.

According to one aspect, to effectively process shear thickening colloids one must not create a force so great as to force the colloidal particles past the point where they pack together and lack any ability to deform around each other. Due to the small passageways that allow treatment to enter a wooden article, control features for a shear thickening fluid require more attention. This attention begins with an understanding of the morphological characteristics of the raw material wooden article, as well as the flow characteristics of the silicate treatment solution and in particular, the point in the rheological curve where thickening occurs, the temperature of the solution and other features as are taught in Berg, et. al. The solution must then be applied to the wood in a reactor that has been subjected to an initial vacuum process and filled at a rate to reduce thickening and a subsequent pressure applied to prevent thickening of the silicate as it enters the wood but allowed to concentrate on the top ¼ inch. Control of treatment flow will require process feedback and attention to detail that is not required for a pure Newtonian type flow solution. Equipment and feedback controls are necessary to retrofit a plant and will require additional equipment, feedback, and control mechanisms, which are available for vacuum pressure impregnation of wood. Secondary treatments that may be further applied require additional controls as they relate to processing shear thickening fluids. Similarly, post treatments such as analysis of treatment depth, quality, and mechanical robustness are retooled differently than would be used for a traditional treatment. These requirements for a shear thickening fluid are also interdependent and as such will require a method to apply feedback and real time adjustments to provide the highest quality impregnation.

According to one aspect, a process control center employs computer aided analysis. This control may be directed by but not limited to, the use of statistical programs, directed control equations, artificial intelligence, or the like.

One aspect of the invention is a method to continuously optimize the treatment efficiency that accommodates for the variability in wood. Implementing an optimization process that utilizes information from raw lumber to be treated, the process variables of the treating process, and the amount of treating material (i.e. silicate), and location of the treating material (i.e. silicate in the top ¼ inch, and a lesser quantity of silicate deeper than ¼ inch.

This optimization process utilizes one or more control modules that collect information from raw material properties, formulation properties, process conditions during treatment, and measurement of the silicate after treatment (location and amount) and utilizes this information to continually adjust conditions to optimize the treatment process for cost, performance, and process time for a colloidal metal silicate solution.

The system may include, but not limited to a CPU, process-machine interfaces, software, PLC, collection ports, database, and an algorithm system. This system can utilize artificial intelligence, statistical and computational analysis, and/or machine learning to continually improve the efficiency of the treating process.

Installing a dispensing system configured to monitor and control the rate of additives and concentration of formulation components and monitor the data feeding back to the one or more control modules. A ratio of SiO₂:Na₂O is critical to a colloidal metal silicate solution and precise metering and monitoring of sodium hydroxide as an additive. According to one aspect of the invention, other metals such as K-Silicates, Li-silicates, or the like can be used.

The method according to one aspect collects formulation information and feeds the collected formulation information back to control module. The system is configured to collect amounts of formulation components added to a mix. Specifically, an amount of added NaOH is collected. The amount of NaOH impacts the SiO₂:Na₂O levels that influence the colloidal properties. Monitoring the specific amount added is important to maintain process control. Additionally, PH levels are monitored and used in the control system.

A process to monitor real time process variables of the treating process to feedback to the one or more control modules govern the efficiency of the treating process using the colloidal metal silicate solution. This may be done in real time with a continual feedback process to control the treatment process and efficiency, or after treating used to improve future treatment processes.

Process variables to be collected and monitored will be, but not limited to, direct variables such as pressure, temperature, and time. The system will also monitor indirect or calculated variables such as rate of pressure, temperature rates, flow rates, and temperature and pressure fluctuations.

One aspect of the invention is a method for retrofitting an existing lumber vacuum-pressure impregnation plant to enhance its ability to treat wood with a shear thickening fluid, specifically a colloidal sodium silicate solution. The process upgrades include adding heated storage tanks, installing specialized delivery lines, and integrating an autoclave capable of handling high-pressure treatment. The system also includes a temperature control and heating system that can maintain or increase the solution's temperature before, during, or after treatment. The heating can occur via a static heating system in the work tanks or a dynamic heating system by heating solution while moving at high pressure through a recirculation system

A pressure control system is introduced to stabilize and monitor pressure during impregnation. One solution is to use compressed air to apply pressure to an accumulation tank, that applies pressure to a combo tank with the colloidal metal silicate solution. The pressure is then applied to the vacuum pressure treating autoclave as it is filled and continues to be pressurized.

A mixing and dispensing system for silicate and additives, ensures precise delivery of formulation using the unique inputs for the flow, shear thickening point and concentration of each batch. A software-based controller tracks and analyzes the entire treatment process using both direct and indirect measurements of lumber properties and real-time feedback on variables like temperature, pressure, and pH.

To further optimize treatment, the system incorporates one or more characterization tools such as stress measurement systems, x-ray or acoustic analyzers, and hyperspectral imaging to assess silicate uptake and wood morphology.

A method to characterize the treated wood and feed back to the control module is used to treat wood in a plant subject to retrofit.

Finally, the invention includes curing methods using CO₂, protic acids, or Lewis acids, with associated infrastructure for application and recovery.

A comprehensive retrofit solution is disclosed that transforms traditional lumber treatment plants into advanced facilities capable of precise, data-driven impregnation of wood with shear thickening colloidal silicates.

The upgraded plant is based on the unique nature of the silicate treating solution. The silicate is a colloidal-shear thickening (STF) solution, also known as Shear Thickening Fluid, which is significantly different than standard treating solutions that are Newtonian in nature. The upgrade process is unique to the disclosed chemistry. Therefore, the plant upgrade is not obvious to one skilled in the art using historical chemistries. The silicate solution is a chemical solution exhibiting non-Newtonian characteristics, i.e., a shear thickening fluid. Non-Newtonian or shear-sensitive liquids change viscosity when under stress or pressure. When flowing by an impeller inside a pump, some liquids become less viscous, a phenomenon called shear thinning. Other fluids become more viscous with increased force, which is called shear thickening or dilatant. A distinctive feature of dilatants is that they get thicker than the shear forces they encounter. The silicate solutions are under stress when they are forced via pressure into the pores of the lumber. Thus, the present specification discloses the process conditions to manage this rheological behavior to achieve efficient impregnation. Due to this shear thickening phenomenon, any fluctuations in pressure, temperature or formulation can enhance the viscosity and decrease the impregnation/treating efficiency.

As noted above, metal silicates are colloidal solutions. A colloidal solution is defined by the Institute of Pure and Applied Chemistry as a “ . . . state of subdivision in which molecules or polymolecular particles having at least one dimension in the range of 1 nanometer to 1 micrometer are dispersed in some medium”. The particles remain suspended and discreet due to their small size and generally look homogenous to the naked eye, but are in fact suspended, thus unlike a true solution, will scatter light and outline the path of the light beam. This latter feature is known as the Tyndall effect and is a characteristic of a colloid. It is this colloidal nature that dictates the non-Newtonian behavior of the solution. The colloidal nature of the solution, and thus the corresponding shear thickening effect, is dependent on the process variables that will apply shear to the solution as well as any formulation variations that impact the ratio of silicate to sodium hydroxide (or the ratio of SiO₂:Na₂O).

The effect of shear thickening is most pronounced when the siliceous solution is forced through the pores of the lumber. Due to the small size of the pores, when the solution is forced through the micron sized cells, the shear stress increases significantly and the viscosity is increased reducing the efficiency of flow and impregnation due to the suspended particles interacting with each other.

An advantageous and surprising result of using a colloidal silicate that is shear thickening is that the treating solution will typically result in a disproportionate amount of silicate near the surface of the wood to be treated, maximizing surface properties such as fire and mold resistance while minimizing the utilization of treating solution and weight of the finished article because less treatment solution is present in the finished product.

In one aspect of the invention, a distinction in the process using sodium silicate is that the sodium silicate may be cured to form a cohesive solid and this may be accomplished by CO₂ application resulting in a lowering of the pH of the impregnated solution. Alternatively, a lowering of the pH can be accomplished in a subsequent step by spraying or soaking the lumber in an aqueous protic acid solution to reduce pH, or alternatively using an aqueous Lewis acid solution.

Due to the unique nature of silicate solutions with the colloidal and STF nature there is a need to transform an existing lumber pressure treatment plant to a cost-efficient, environmentally-friendly, i.e. all-green plant for treating wood, that can eliminate toxic chemicals and provide enhancing strength properties, increased fire resistance ratings that meet or exceed current international and domestic recognized building and building materials standards, while maintaining other desirable properties such as resistance to rot, bacteria, and insects while also providing other desired properties without using toxic chemicals. The transformed lumber treatment plant is capable of treating wood according to the methods disclosed in U.S. Patent Publication 2021/0170623 entitled Green Process for Modifying Wood, the content of which is incorporated herein by reference.

According to one aspect of the invention, the manufacturing process/method for processing timber begins with the insertion of kiln strips into lumber packets. Alternatively, the process/method may be performed without inserting kiln strips in the lumber packets. Next, the lumber packets are strapped and then the impregnation process can begin in the autoclave. Once the lumber is inserted into the autoclave, the autoclave is placed under vacuum. According to one aspect of the invention, the vacuum is −10 to −28 inches Hg for up to or about 45 minutes. The process chemicals disclosed in the aforementioned patent publication are next inserted into the autoclave for a requisite time at an elevated pressure and elevated temperature. The silicate solution is preheated to 60-85° C., although a broader temperature range between 40-90° C. can be used. The solution once introduced is then pressurized at 100-200 psi for up to 120 min, followed by vacuum between −10 to at −28 in Hg for about up to 20 minutes. Next a vacuum is again drawn on the wood in the autoclave, which then may be filled with carbon dioxide and allowed to remain under pressure for periods of time ranging from 20 minutes to 24 hours. While these ranges are exemplary, a broader range is conceivable. The carbon dioxide is then removed by, again, placing the autoclave under vacuum and recycled or trapped. Once the vacuum is released, the lumber is removed from the autoclave and allowed to dry for 24 to 48 hours. Optionally, the lumber is then reinserted into the autoclave. A vacuum is drawn and the process chemicals are injected into the autoclave for a second time at elevated pressure and elevated temperature. The chemicals are then removed by drawing a vacuum on the autoclave, and may be followed by a second treatment with CO₂ or alternatively removed from the autoclave and kiln dried by elevated temperatures to industrial standards (for example the lumber must be at or below 19% moisture content for KD19 for dimensional lumber and at or below 15% moisture content for KD15 for plywood). The temperatures and time are designed to meet these standards. It should be noted that the temperature and cycle times may vary depending on environment conditions, load sizes, wood sizes, at the time of drying. After drying, the kiln strips are removed and the lumber is brushed and stamped. The brushed and stamped lumber is then ready for sale to market. Optionally, the treated wood may be cured by exposure to protic or Lewis acids, or CO₂.

This disclosure presents a cost-effective solution to transform or repurpose existing lumber processing plants by making novel technical changes to pre-existing plants. Not only is this cost effective, but once the reactors have been thoroughly cleaned and modified, a potentially hazardous waste condition at existing plants can be eliminated.

The wood pressure treatment plant is configured to perform a wood vacuum-pressure impregnation process that accommodates treating with silicate with the unique features of a colloidal solution that is a shear thickening fluid (STF). The plant to be modified has a pre-existing vacuum pressure impregnation tank, feed lines, vacuum pump(s), and a wood transport system.

At least the following additions and modifications are made to the existing plant for non-toxic and environmentally sustainable processing:
Installing, if not already present, an autoclave capable of handling a siliceous solution pressurized at approximately 200 psi The autoclave applies the pressure utilizing a compressor pump, that pressurizes an accumulation tank, and then applies pressurizes to a combo tank followed by applying pressure to the autoclave. This process minimizes pressure fluctuations that may activate the shear thickening effect as silicate interacts with the pores of the wood;
adding and/or replacing delivery lines with delivery lines capable of handling high pH, shear thickening solutions at elevated temperatures;
adding one or more CO₂ storage tank(s) each with an associated vaporizer and delivery lines;
adding a CO₂ recovery system;
adding an optional dip tank or spray booth to apply aqueous low pH solution or aqueous multivalent metal ions solutions for curing. This may be carried out prior to or after kiln drying;
adding one or more pumps and filter pumps capable of handling high pH, shear thickening solutions; and
adding or modifying a thermal management system comprising insulation and cladding on all vessels and, where feasible, on the delivery lines, temperature tracing, level indicators, which are typically magnetic float type indicators, and heating coils that are inserted in working tanks;
adding an optional high-pressure recirculation and valve system, connected to the main treatment cylinder, the existing or new solution tanks and a circulation heater (in-line heater), which provides for maintaining or increasing solution temperature before, during, or after treatment. High pressure is considered to be 200 PSI.adding a mixing system that allows for the addition of additives to create or modify formulations such as NaOH for specific SiO₂:Na₂O ratios.

In addition to modifications to the manufacturing infrastructure, further refinements will be necessary to continually improve the impregnation efficiency due to the nature of the colloidal silicate solutions. This will include an optimization system that includes the ability to program into a control system a multistep treating process.

Another critical component is the inclusion of an ability to inline or offline measure properties of wood such as density, morphology, and/or porosity and adjust process conditions to optimize treating.

including an ability to inline or offline measure an amount and location of silicate treatment and use this to adjust the process conditions for optimal treatment efficiency. This information will be incorporated into a feedback system to design the lumber article to have a disproportionate amount of silicate near the surface allowing for maximum surface properties such fire resistance, mold resistance, while keeping the utilization of treating solution to a minimum along with the weight of the lumber article.

According to one aspect of the invention, a process control information system is installed that is configured to manage, monitor, and record the wood vacuum pressure impregnation process and other related processes. The process control information system is further configured to optimize key performance indicators including, silicate solution temperatures, autoclave pressures, and vacuum, pressurization and carbon dioxide cycles durations.

According to one aspect of the invention, software is added to an existing or upgraded Programmable Logic Controller (PLC) system to function in conjunction with digital and mechanical recording devices to track, record, and analyze the process variables in real time for sodium silicate solutions. The process variables include solution temperature, autoclave pressure, amounts of solution utilized, storage tanks and treatment autoclave temperatures, duration of each stage of the process, and correlations between these variables. The software provides the collected data that can be used to further optimize the process. This software will have the ability to utilize data collected on the incoming lumber properties, and the final impregnation properties with a feedback loop to optimize the treating process; specifically, maximizing properties while minimizing the amount of treatment chemicals by the placement of the majority of the chemicals closer to (but not exclusively) at the top ¼″ surface of the lumber article while still maintaining a lower amount of chemicals throughout the lumber article.

The sodium silicate solutions require processing equipment that can handle a polar, caustic, aqueous solution that possesses non-Newtonian characteristics (STF) to impregnate the wood.

According to one aspect of the invention, the pH of the silicate solution may be between 9 and 14, or may be below 4.

According to one aspect of the invention, the insulation, which is the material that prevents heat loss and serves as the actual thermal insulator, is typically fiberglass, and the cladding is a protective coating over the insulator, typically a corrugated metal.

According to one aspect of the invention, the components are added so that a two-step impregnation process can be performed.

One aspect of the invention is that the properties of the wood are measured prior to treatment. These properties may be but not limited to, weight, moisture content, and density, and porosity. This data is then applied to a controller that will be used to increase the impregnation efficiency and optimize the resource utilization such as amount of treatment solution and process time.

Another aspect of the invention is that the process may incorporate an inline or offline measurement of the amount and location within the lumber of the silicate treating material. The data from these measurements are fed back to a controller and aid in increasing the impregnation efficiency and optimizing the utilization of resources such as treating solution, and processing time.

According to one aspect of the invention, an in-line machine stress measurement system may be added for the lumber following the impregnation step for silicate uptake quantification. There are several alternatives to implement the stress measurement system. A first alternative may be a device configured to measure density of wood by removing a small sample and plotting density. A second alternative is an industrial scale lumber strength measuring device that uses X-ray and other imaging technology to assess lumber. This device can determine density of both finished product and to grade incoming lumber to preferentially shift lower density wood for impregnation. This device can also perform natural frequency analysis. Another alternative would be a system that uses sound transmission. Such a system can be adapted to analyze the filled silicate composites because the silicate filler will change the density of the wood and could be measured by this technique non-destructively. Additionally, or alternatively, bending stress measurements can be used.

According to one aspect of the invention, a hyper-spectral analyzer system, an x-ray analyzer, or acoustic analyzer system may be added so that the lumber can be analyzed for wood morphology analysis both before and after impregnation. Hyperspectral analysis measures spectroscopic data across a variety of wavelengths, typically in the near infrared for wood, to determine a surface composition of the product.

According to one aspect of the invention, a natural frequency measurement system may be added for silicate uptake quantification. Natural frequency is a characteristic vibration mode of a material. It is obtained in much the same manner that one would use to get a tuning fork to resonate. The wood beam is struck and the resulting frequency is measured.

The data from each of these measurement techniques may be used with a feedback loop to optimize the treating process; specifically, maximizing properties while minimizing the amount of treatment chemicals by the placement of the majority of the chemicals closer to the surface while still maintaining a lower amount of chemicals throughout the lumber article.

According to one aspect of the invention, a multi-input solution dispensing system may be added upstream of the feed lines into the impregnation tank(s) for formulation control and quantification, which are capable of delivering two or more impregnation charges.

The multi-input solution dispensing system may include:
a. A mixing system that controls the formulation parameters of the treating solution, for example the concentration (weight) of silicate and sodium hydroxide is important as it will define the ratio of SiIO₂:Na₂O that dictates the colloidal nature and shear thickening effect. Additional formulation components can also be incorporated with the mix system; and/or
b. A dispensing system that allows for adjusting the formulation at various stages of the process and is configured to be controlled by the feedback of the process conditions. This may include the active inclusion of pH buffers and/or impregnation aids.

According to one aspect of the invention software is used in the facility to work with digital and mechanical recording devices programmed to track, record, and analyze the key process variables in real time including solution temperature, autoclave pressure, amounts of solution utilized, storage tanks and treatment autoclave temperatures, duration of each stage of the process and correlations between these variables.

The optimization system is designed to use artificial intelligence, statistical and computational analysis, or machine learning processes to drive algorithms to improve the impregnation efficiency specific to the use of colloidal metal silicates with the surprising result of disproportionally more silicate in the top ¼ inch of the wood. This results in optimizing properties that are surface related while minimizing weight and manufacturing resources.

### BRIEF DESCRIPTION OF FIGURES

The invention will be described in more detail on the basis of an exemplary embodiment. In the figures:

FIG. 1 is a flow chart showing a conventional wood treating process;

FIG. 2 is a schematic layout for a transformed lumber processing plant;

FIG. 3 is a flow chart for upgrading a treating plant to a green-silicate based impregnation process;

FIG. 4 is a schematic process used to apply pressure to the autoclave while dampening fluctuations;

FIG. 5 is a flow chart for a system to regulate heat and temperature fluctuations

FIG. 6 is a flow chart of curing the siliceous treating solutions;

FIG. 7 is a flow chart of a mixing and dispensing system; and

FIG. 8 is a flow chart for the optimization system and information and data flow;

### DETAILED DESCRIPTION OF THE FIGURES

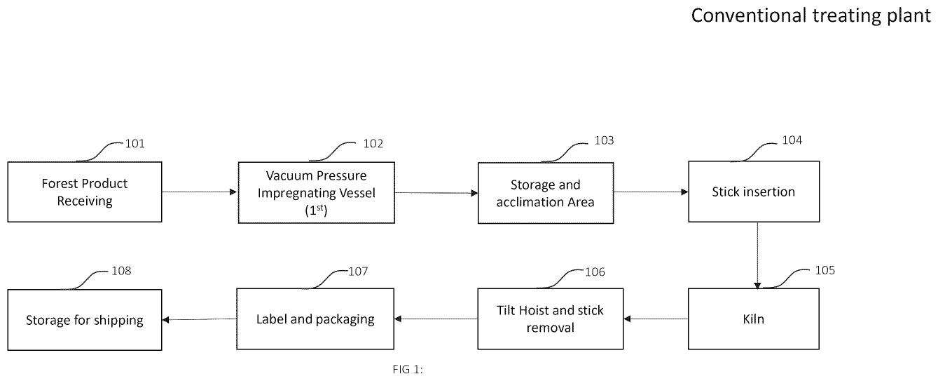

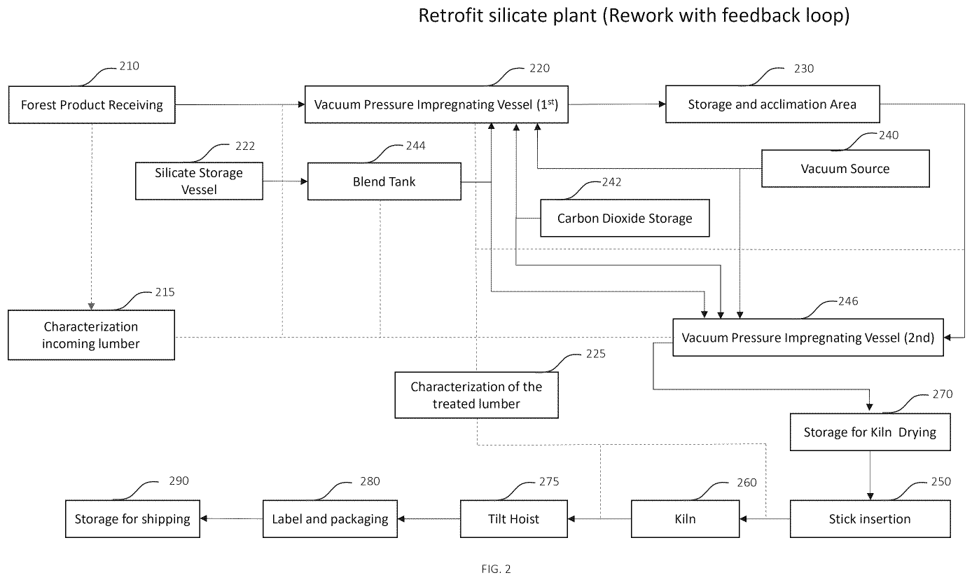

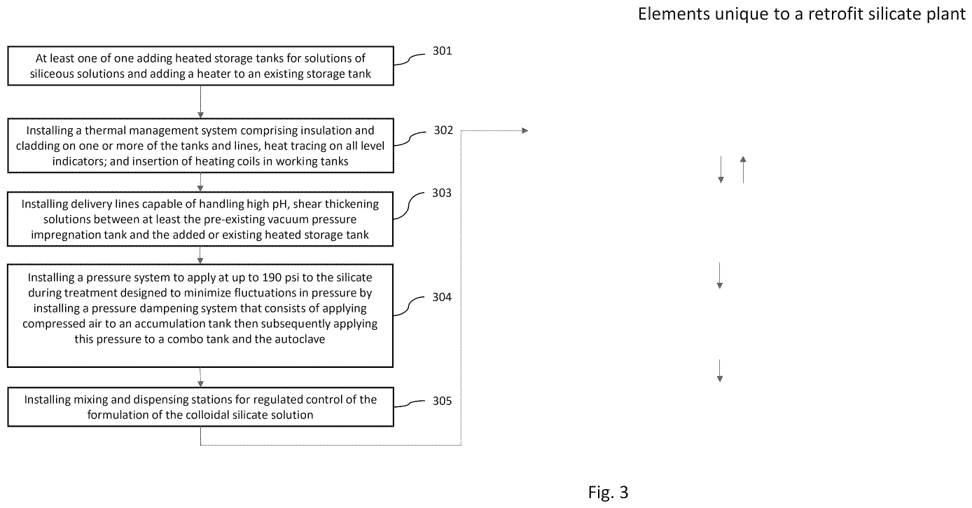

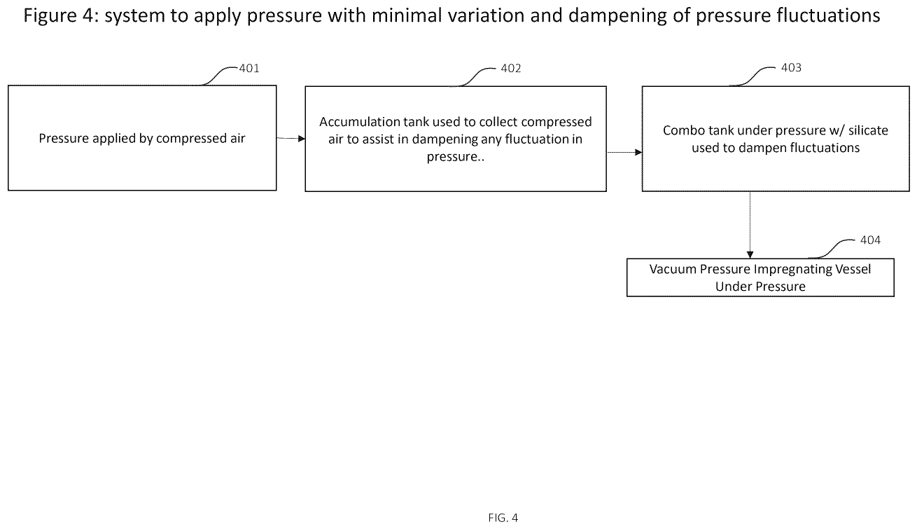

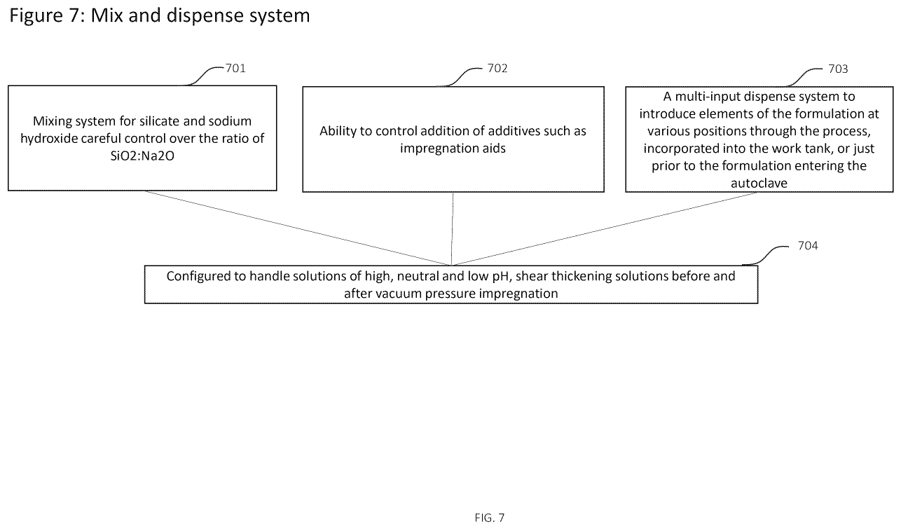

A transformed southern pine wood pressure treatment plant uses a non-toxic and environmentally sustainable process for modifying wood using colloidal sodium silicate formulations (with STF properties) or other environmentally friendly formulations. An exemplary implementation of the conventional treatment process is shown in FIG. 1. FIGS. 2 and 3 represent the implementation of a treatment plant and process flow for a colloidal silicate solution that is shear thickening. The impregnation liquid is prepared by mixing a silicate mix with water in a feed tank. Optionally, using a mix and dispense system discussed below with respect to FIG. 7, sodium hydroxide or other impregnation efficiency inducing compounds including, but not limited to, surface acting agents added to this feed tank. The solution preparation can include multiple additives for treatment. The mixture can be pumped to a working tank for heating and agitation, or as desired can be included using a dispensing system at various stages in the process. Optionally, the lumber is characterized for density, weight, moisture content and/or porosity. This information may be supplied to the control system to determine formulation and/or process conditions. Once a size of lumber is selected and characterized, the untreated lumber is placed in an impregnation vessel/autoclave. The autoclave is placed under vacuum and then the liquid mixture from the working tank is added to the impregnation vessel/autoclave. Once the liquid mixture is added, pressure is applied to the autoclave. This is accomplished by applying compressed air to an accumulation tank that applies pressure to a combo tank and then the autoclave. This method aids in reducing the pressure fluctuations that may enhance shear thickening that may be present at the point where the solution enters the porosity of the lumber as discussed below referencing FIG. 4. Next, pressure is reduced and the impregnation vessel/autoclave is placed under vacuum. Optionally, a second impregnation step is included that involves addition of a second, typically higher concentration of impregnating solution to the autoclave. After the impregnation vessel/autoclave is placed under vacuum, gaseous carbon dioxide from carbon dioxide processing apparatus is introduced into the impregnation vessel/autoclave. Next, the treated lumber is removed from the impregnation vessel/autoclave.

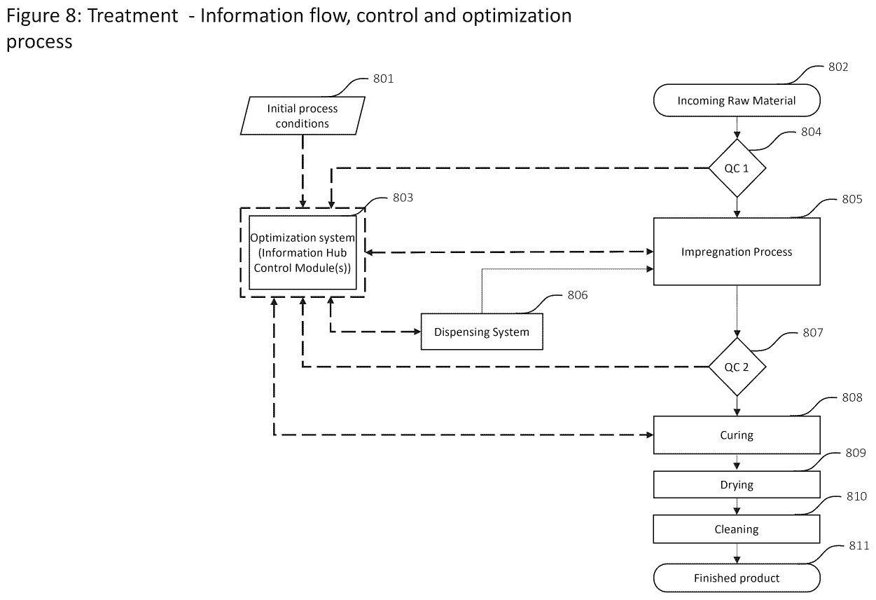

According to one aspect on the invention, certain quality control testing is performed to evaluate the treatment process. These processes are developed and customized to know if the impregnation has been successful. This process also allows for an assessment of the amount and location within the lumber of the colloidal silicate solution. This information is supplied back to the control system to enhance the algorithm used for future treatments as discussed below referencing FIG. 8. The treated lumber is then heated and dried using a conventional sawmill kiln.

According to one aspect of the invention, a second impregnation process is performed. This second impregnation can be performed in the same equipment or using additional processing equipment. The once-treated lumber is loaded into the pressure vessel where it undergoes vacuum, pressure, and vacuum cycles. According to one aspect of the invention the lumber may be dried a second time. It should be noted that the double vacuum impregnation process does not necessarily require a kiln dry step between as these steps can be performed sequentially without drying in between the two impregnation processes.

A surface cleaning may be performed on the treated lumber. Next, the treated lumber can undergo a quality control analysis. The treated lumber is then stamped, bundled, and packaged for shipping.

To perform the impregnation process above, an existing, conventional southern pine (SYP) lumber pressure treatment plant has to be modified. A conventional lumber pressure treatment plant typically includes a lumber infeed chain, a chemical storage system, a water storage system, a treatment chemical blending tank, a feed product tank, an autoclave where the lumber impregnation takes place, and a drip tray for product draining.

Preferably, the conventional equipment for the conventional treatment process is used for the upgrades and modifications. Alternatively, the conventional equipment can be replaced.

A large product delivery tanker offloading station, with associated piping is added. The new or existing chemical storage tank(s) are insulated with insulating material and cladded with a protective material. Insulation and cladding is also added to the feed line(s) between the storage tank and the blending tank, to the blending tank, and to the product feed line(s) to and from the working tank and to and from the autoclave.

According to one aspect of the invention, to heat the product a heating coil is installed in each of the working tanks. The heating coils are preferably horizontal coils inserted in the vessels. Heat tracing of the level indicators are added or upgraded for each of the working tanks, the blending tank, the autoclave, and the chemical feed tank. The change or addition of the heat tracing components is a precaution because typical level indicators are magnetic float indicators, which would be impacted by the higher viscosity chemical solution.

According to one aspect of the invention, an updated tote system for adding specialty chemicals to the main blending tank is installed. Totes are large plastic containers that hold liquids. In operation, a feedline is inserted into a tote and the liquid pumped out of the tote. Furthermore, a digitally controlled chemical feeder system can be installed and used to accomplish the specialty chemicals blending more precisely and efficiently. Optionally, rather than totes, tanks may be installed with corresponding delivery lines to introduce the chemicals to a work tank directly without operator interaction. This is beneficial since the formulation of the colloidal silicate will dictate the degree of shear thickening.

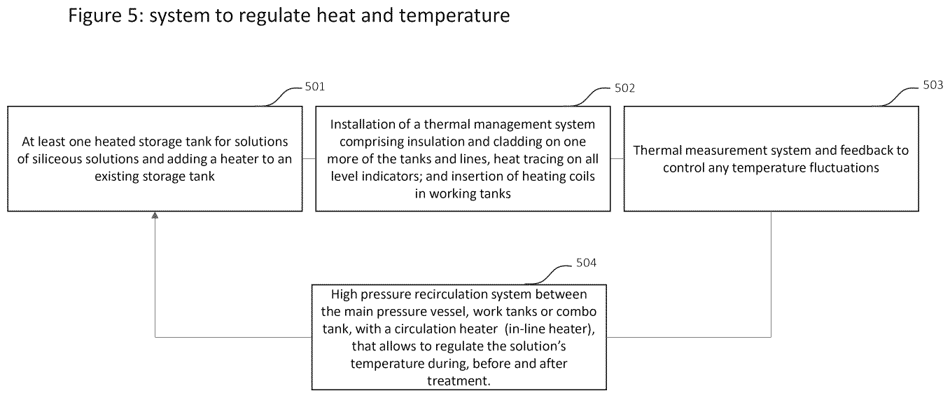

As stated previously, the system in FIG. 5 is utilized to minimize any pressure fluctuations that may enhance the shear stress when the siliceous solution flows into the pores of the wood.

The pumps and filters in the conventional plant are also upgraded. The pumps circulate treatment solution between storage tanks and treatment vessels as well as circulate treatment solution within the tanks and vessels. The enhanced pump is configured to pump the higher viscosity and shear thickening chemical solution to the working tanks without causing shear thickening. The pumps preferably use a filter sock type filter or other filter method can be used.

A carbon dioxide storage tank and associated vaporizer are installed, with a feed and return line to the autoclave. In addition, one or more double plug block valves with actuators are installed in these two lines.

If liquid protic or Lewis acid is used instead of CO₂, a spray system or a dip tank with aqueous curing solution is provided. One embodiment of this process may be incorporated after the autoclave treatment prior to kiln drying. In another embodiment this process may be incorporated after kiln drying

One embodiment may be to include a vacuum pressure impregnation step of a low pH solution.

According to one aspect of the invention, the piping in the conventional factory is rerouted to allow unimpeded flow of the higher viscosity or shear thickening silicate solutions. This re-routing may vary depending on the specific design of the existing plant, but should have as a priority removing flow constrictions, introducing unnecessary turbulence, and be as direct as possible.′

Any fluctuations in pressure or temperature may have an impact of the solution as it impinges on the lumber surface during treatment. These fluctuations may have the effect of increasing the shear thickening behavior as the solution is forced through the small pores and cells of the lumber. Minimizing fluctuations and keeping them below the shear thickening point in the process is important to provide uniform impregnation.

The existing plant piping preferably remains intact, but changes are made to the working tank filter and pump system as noted above. In addition, all piping is insulated and clad to keep heat losses to a minimum to accommodate the operating temperatures of 40° C. to 100° C. It should be noted that piping upgrades are necessary if the existing piping is unable to handle the STF of the present process.

To maintain the operating temperatures, heating coils are added as well as insulation and cladding, as discussed above. Inline heaters can also be added to maintain or increase solution temperature. The heating coils maintain the chemical mixture, referred to as the product, at a temperature of approx. 40-90° C. While some steps in the impregnation systems may use chemicals at room temperature, the steps that require heated chemicals are more energy efficient when thermal insulation is provided, thus providing more consistent process results, and reduce product material losses.

Carbon dioxide gas may be used in the process for the precipitation of the chemical added to the wood, through the lowering of the pH. Therefore, a CO₂ gas storage delivery and recovery system is installed. A liquid carbon dioxide storage vessel is installed, along with the requisite vaporizer. A two inch piping system is installed and fed into a rear top area of the autoclave as well as a return vent line.

According to one aspect of the invention, upgrades to the plant programmable logic controller (PLC) system are also installed. The existing PLC control system can be used but must be upgraded with logic changes and the addition of the new control loops, as well as appropriate software upgrades. The upgrades are provided at least in part in the temperature indication and control system. This upgrade is important for steady state operation where multiple impregnation cycles are taking place. The addition of fresh chemicals to the process on an ongoing basis requires a fast heater response and this logic is provided by the upgraded PLC.

According to one aspect of the invention software is added to the Programmable Logic Controller (PLC) system to function in conjunction with digital and mechanical recording devices programmed to track, record, and analyze the key process variables in real time. The process variables include solution temperature, autoclave pressure, amounts of solution utilized, storage tanks and treatment autoclave temperatures, duration of each stage of the process and correlations between these variables. The collected data can be used to further optimize the process.

In a conventional treatment process, the lumber is stacked in “packets” with one layer on top another. For the modified plant and process kiln strips are inserted prior to the treatment process. The kiln strips achieve two objectives. First, the kiln strips ensure that the lumber is well impregnated by providing space between layers. Second, the kiln strips allow the product to be kiln dried to reach the KD19 standard (Kiln-Dried to 19% moisture content).

This modified process using kiln strips comprises receiving wood, inserting kiln strips, strapping lumber packets, performing a one or two step impregnation operation, kiln drying the material, breaking down the packets and removing the kiln strips, and preparing final lumber packets for dispatch.

FIG. 2 is a schematic process layout for a transformed wood processing plant for the wood treatment process of FIG. 1. The wood processing plant has a timber receiving section 210, which may be the same or different than the storage and shipping area 290. The incoming lumber is characterized at 215. The properties of the lumber are determined that will be used to determine the process variables such as solution concentration and the like. The transformed wood processing plant includes one, two, or more vacuum pressure impregnation vessels 220, 246. If space permits, two or more vacuum pressure impregnation vessels 220, 246 are installed.

The first pressure impregnation vessel 220 is coupled to a silicate storage vessel 222 via a blend tank 224. There is also a vacuum source 240 and carbon dioxide storage 242 coupled to the first pressure impregnation vessel 220. A storage and acclimation area 230 is provided for the lumber that is processed in the first pressure impregnation vessel 220.

The second pressure impregnation vessel 246 is coupled to the silicate storage vessel 222 via a blend tank 244. Alternatively, a second silicate storage vessel and blend tank can be added. The vacuum source 240 and carbon dioxide storage 242 are also coupled to the first pressure impregnation vessel 220. Alternatively, a second vacuum source and carbon dioxide storage can be added. It should be noted that the vacuum sources can be the same or different. Further, the carbon dioxide storages can be the same or different. Piping can be provided so that only a single vacuum source and/or carbon dioxide storage is required, as shown.

After impregnation in the first and/or second impregnation vessel(s) 220, 246, the treated lumber is characterized at 215. The properties of the treated lumber are determined that will be used to determine or modify the process variables such as solution concentration and the like.

A storage for kiln drying 270 is provided for the kiln 260 in which the processed lumber is dried. Tilt hoist 275 is used to lift and tilt the lumber. Characterization of the treatment process is performed prior to or after kiln drying. This data is provided back to the controller to optimize subsequent treatment processes. A label and packaging station 280 is provided as well as a storage area 290 for shipping. previously mentioned, the storage area 290 can be the same or different than the timber receiving area 210.

FIG. 3 is an overview of the steps to transform and/or update a treatment plant. The steps can be performed in any order but are presented in accordance with one aspect of the invention. At 301, heated storage tanks for solutions of colloidal siliceous solutions are added and/or a heater is added to an existing storage tank. At 302, a thermal management system comprising insulation and cladding on one or more of the tanks and lines, heat tracing on all level indicators, and insertion of heating coils in working tanks is installed.

Delivery lines capable of handling high pH, viscous shear thickening solutions are installed between at least the pre-existing vacuum pressure impregnation tank and the added or existing heated storage tanks at 303.

At 304, a pressure system to apply up to 190 psi to the silicate during treatment designed to minimize fluctuations in pressure is installed. Pressure fluctuations are minimized by installing a pressure dampening system that includes the ability to supply compressed air to an accumulation tank then subsequently applying this pressure to a combo tank and the autoclave. An exemplary system is discussed with respect to FIG. 5 below.

At 305 mixing and dispensing stations for regulated control of the formulation of the colloidal silicate solution are installed. Software for a controller configured to track, record, and analyze the process from incoming lumber, treatment and post treatment quantification is installed. If required, a new controller is installed or upgraded if necessary. The system is configured to characterize incoming lumber with feedback to the controller and characterize silicate impregnation with feedback to controller.

An optimization system with installed hardware and software for a control module is installed at step 306 that is configured to track, record, and analyze the process from incoming lumber, treatment, and post treatment quantification. The optimization system includes feedback and control modules to characterize incoming lumber installed at 307. Further feedback and control modules for the characterization of silicate impregnation are installed at 308.

At step 310, a CO₂ storage tank with associated vaporizer and a CO₂ recovery system is added. If necessary, associated lines to and from the pre-existing vacuum pressure impregnation tank and the CO₂ storage tank and the CO₂ recovery system are installed. Pumps are installed for circulating the solutions.

A spray or soak station is installed that is configured to apply an aqueous acid solution for curing the colloidal silicate at step 311.

If curing of the silicate is accomplished by the use of a Protic or Lewis acid, a dip or soak tank may be incorporated (311). Alternatively, a spray system may be used to introduce the aqueous acidic solution to the surface of the treated lumber. In some applications the use of an acidic vapor may be desirable and a heated chamber to deliver and contain them may be added to the process.

In one embodiment, a mixing system is installed to control the formulation and introduction of additives to the silicate solution and if desired perform real time measurements of solution flow and shear thickening point as a function of microfluidic chamber diameter. Another embodiment is the addition of a pressure regulation system that incorporates a pressure pump that provides pressure to a tank (combo tank) followed by an accumulation tank. This system then applies pressure to the autoclave thus reducing the fluctuations in pressure during treating.

FIG. 4 is a detail of the system to apply pressure with minimal variation that dampens pressure fluctuations. Minimizing pressure fluctuations is important when moving shear thickening fluids through the system because changes in flow rates will have a direct impact on impregnation. In system according to one aspect of the invention, pressure is applied by compressed air at 401. An accumulation tank collects and stores compressed air to assist in dampening any fluctuation in pressure at 402. A combination tank under pressure with silicate is used to dampen fluctuations. The combination tank is coupled to the accumulation tank. The combination tank is also coupled to a vacuum pressure impregnating vessel that is also under pressure. By using compressed air and an accumulation tank, pressure fluctuations are minimized, which reduces impact on the shear thickening fluid.

FIG. 5 is the upgraded system to regulate heat and temperature. At least one heated storage tank for solutions of siliceous solutions is provided or a heater is added to an existing storage tank at 501. As discussed above, a thermal management system comprises insulation and cladding on one more of the tanks and lines, heat tracing units, level indicators, and heating coils in the working tanks. As required, insulation and cladding on one more of the tanks and lines is installed, heat tracing on all level indicators are added, and heating coils in working tanks are installed at 502. The thermal measurement system is configured at 503 to provide feedback to control temperature fluctuations. At 504, a high pressure recirculation system arranged between the main pressure vessel, work tanks or combo tank, includes a circulation heater, that allows to regulate the solution's temperature during, before and after treatment. According to one aspect of the invention, the circulation heater is an inline heater. The feedback provides real-time data for improved process control including but not limited to pressure, temperature, and flow rates.

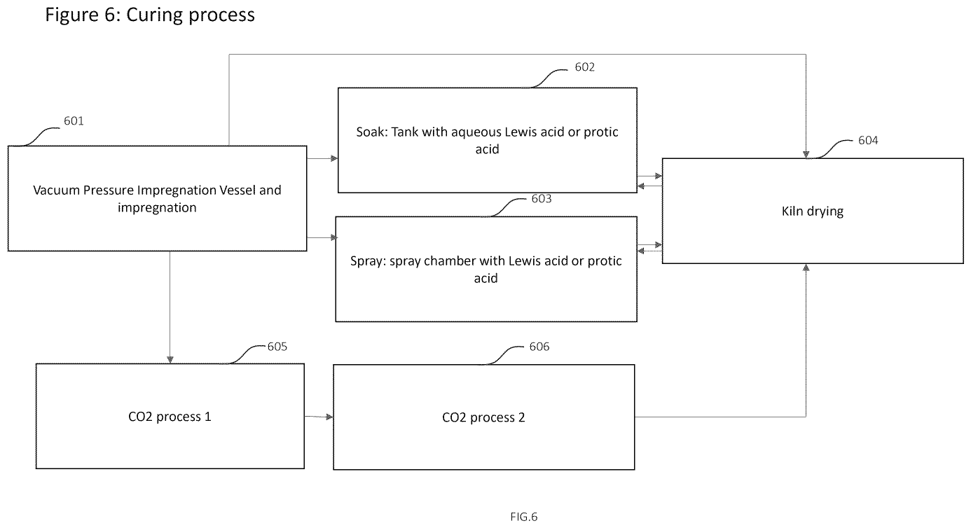

FIG. 6 depicts the curing process. Initially at 601 the lumber is placed in a vacuum pressure impregnation vessel for impregnation. The impregnation vessel impregnates the lumber with the shear thickening fluid. The impregnated lumber is either soaked in a tank with aqueous Lewis acid or protic acid 602 or sprayed in a spray chamber with Lewis acid or protic acid 603. The lumber is then dried in a kiln 604. It should be noted that the soaking 602 or spraying 603 can be bypassed and the lumber can go directly from the impregnation vessel to the kiln. It should be noted that according to one aspect of the invention, after each vacuum impregnation there is a CO₂ treatment 605, 606. Alternatively, only one CO₂ treatment is performed after the second vacuum impregnation.

FIG. 7 provides details of the mixing and dispensing system. A mixing system for silicate and sodium hydroxide that has fine control over the ratio of SiO₂:Na₂O is provided at 701. The mixing system has the ability to control the addition of additives such as impregnation aids into the formulation at 702. According to one aspect, the system has a multi-input dispense system 703 that introduces elements of the formulation at various positions through the process, such as incorporated into the work tank, just prior to the formulation entering the autoclave, or other points in the process as required. At 704, the system is configured to handle solutions of high, neutral and low pH, and the shear thickening solutions before and after vacuum pressure impregnation. According to another process may contain feedback sensors or shunts to provide real-time data on formulation rheological characteristics.

One aspect of the invention is a feedback algorithm and system for efficiency in utilization of resources shown in FIG. 8. Initially, at 801 an initial set of process conditions are established or set. At 802 incoming material is received. At a first quality control step, QC1, incoming lumber is characterized. The controller collects and analyzes data from the characterization at QC1 with an algorithm to adjust process variables for the impregnation process at 805. The controller 803 also collects process variable data from the vacuum pressure impregnating vessel and process. The collected data from the vacuum pressure impregnating vessel is used to characterize silicate amount and location in the processed lumber. This characterization of silicate amount and location from 804 is fed back to the controller at QC2, 807 to improve efficiency and processing. The control module(s) 803 also control the dispensing system 806 and the curing process 808. The control module(s) 803 can also control the drying process 809 and cleaning process 810. The control module(s) 803 preferably keep track of finished products 811 as well.

The control module(s) 803 receive data from sensors such as thermal sensors, pressure sensors, flow rates, stress measurements, x-ray or acoustic analyzer data, and hyperspectral imaging data to assess silicate uptake and wood morphology to determine and modify process efficiency and control.

The testing of raw material and final testing of impregnation is used to improve process parameters and continually improve impregnation efficiency. This analysis and feedback ties the hyperspectral analysis, Near InfraRed (NIR) data, Machine Stress Rated (MSR) data, concentration details of the impregnation system, etc. with an active method to dictate process variables and modifications to the process. The ability to collect information from incoming wood properties at QC1 804, dispense and formulation details, and silicate efficiency at QC2 807 are used to define processing parameters for optimal impregnation. Using the controller and software to collect data from wood properties, formulation parameters via a dispense system, and impregnation efficiency (i.e. silicate amount and location in the treated wood) optimizes the processing parameters to continually improve the vacuum impregnation process efficiency.”

The control module(s) 803 are one or more computers, PLCs, or the like running software that control the system and processes.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method of upgrading a lumber vacuum-pressure impregnation process plant having a pre-existing vacuum pressure impregnation tank, feed lines, an original vacuum pump, and a lumber transport system to impregnate lumber with a shear thickening fluid comprising colloidal metal silicate solution configured as sodium silicate, comprising:
at least one of adding heated storage tanks for solutions of siliceous solutions and adding a heater to an existing storage tank, configured to fill and remove the solutions to the pre-existing vacuum pressure impregnation tank;
installing delivery lines capable of handling high pH, viscous solutions between at least the pre-existing vacuum pressure impregnation tank and the added or an existing heated storage tank;
installing a CO₂ storage tank with associated vaporizer and a CO₂ recovery system;
installing associated lines to and from the pre-existing vacuum pressure impregnation tank and the CO₂ storage tank and the CO₂ recovery system;
installing pumps for circulating the shear thickening fluid;
install a pressure monitoring system configured to:
reduce pressure fluctuations;
controlling a rate of pressure; and
monitor pressure and provide feedback to monitor impregnation;
adding or upgrading level indicators in one or more of the vacuum pressure impregnation tank and the heated storage tank configured to impregnate silicate into the lumber with a disproportionate amount near a wood surface, wherein a resulting weight is of the lumber is less than a fully impregnated lumber;
installing a dispensing system configured to control a rate of additive addition and concentration to minimize gelation and control a colloidal effect of the shear thickening fluid;
installing software for a controller configured to track, record, and analyze process variables for sodium silicate solutions, wherein the process variables include one or more of solution temperature, autoclave pressure, amounts of solution utilized, storage tanks temperatures, treatment autoclave temperatures, and duration of each stage of the process, wherein the software is configured to cause the controller to:
utilize indirect measurement and feedback to determine density and porosity of the lumber,
control and monitor flow rates,
control and monitor pressure;
control and monitor the rate of pressure;
control solution pH including control feedback; and
determine solution levels for treatment; and
installing a thermal management system configured to minimize temperature variations comprising:
insulation and cladding on one or more of the tanks and lines;
heat tracing on all level indicators; and
insertion of heating coils in one or more of the vacuum pressure impregnation tank and the heated storage tank.

2. The method of upgrading the lumber vacuum-pressure impregnation process plant in claim 1, further comprising:
installing a second vacuum pressure impregnation tank and associated feed lines.

3. The method of upgrading the lumber vacuum-pressure impregnation process plant in claim 2, further comprising:
upgrading or replacing, the pre-existing vacuum-pressure impregnation tank for an impregnation process for silicate impregnated wood.

4. The method of upgrading the lumber vacuum-pressure impregnation process plant in claim 3, further comprising:
installing an in-line kiln for drying sodium silicate impregnated wood.

5. The method of upgrading the lumber vacuum-pressure impregnation process plant in claim 3, further comprising:
installing an in-line machine stress measurement system that quantifies silicate uptake and configured to provide feedback to the controller.

6. The method of upgrading the lumber vacuum-pressure impregnation process plant in claim 1, further comprising:
installing an x-ray analyzer, or acoustic analyzer system for wood morphology analysis and configured to provide feedback to the controller.

7. The method of upgrading the lumber vacuum-pressure impregnation process plant in claim 3, further comprising:
installing a natural frequency measurement system configured to quantify silicate uptake, and
configured to provide feedback to the controller.

8. The method of upgrading the lumber vacuum-pressure impregnation process plant in claim 1, further comprising:
installing a multi-input solution dispensing system prior to feed lines into the pre-existing vacuum pressure impregnation tank wherein the multi-input solution dispensing system is configured for formulation control, quantification, and delivering two or more impregnation charges.

9. The method of upgrading the lumber vacuum-pressure impregnation process plant in claim 1, further comprising:
installing a delivery system configured to dispense aqueous solutions of high, neutral, and low pH solutions before and after the vacuum pressure impregnation tank.

10. The method of upgrading the lumber vacuum-pressure impregnation process plant in claim 1, further comprising:
installing an immersion delivery system configured to dispense aqueous solutions of high, neutral, and low pH solutions before and after the vacuum pressure impregnation tank.

11. The method of upgrading the lumber vacuum-pressure impregnation process plant in claim 1, wherein at least one of the solutions is a high pH viscous solution.

12. The method of upgrading the lumber vacuum-pressure impregnation process plant in claim 1,
wherein a hyper-spectral analyzer system for wood morphology analysis is arranged for use before and after impregnation in the vacuum pressure impregnation tank, and configured to provide feedback to the controller.

13. The method of upgrading the lumber vacuum-pressure impregnation process plant in claim 1, further comprises:
installing an accumulation tank configured to receive compressed air from a compressor and provide compressed air to a tank storing the siliceous solution.

14. The method of upgrading the lumber vacuum-pressure impregnation process plant in claim 13, further comprising:
installing an autoclave configured to handle the siliceous solution pressurized to at least 190 psi, wherein pressure fluctuations are minimized.

15. The method of upgrading the lumber vacuum-pressure impregnation process plant in claim 1, further comprising:
adding at least one of a dip tank or a spray booth to apply an aqueous low pH solution or an aqueous multivalent metal ions solutions for curing.

16. The method of upgrading the lumber vacuum-pressure impregnation process plant in claim 1, wherein the controller is further configured to:
collect data regarding incoming wood properties;
determine formulation requirements and formulation dispensing parameters; and
determine silicate impregnation efficiency to define processing parameters for optimal impregnation.

17. A plant to perform a lumber vacuum-pressure impregnation process, comprising:
timber handling equipment configured to transport timber from a receiving area to a plurality of stations, wherein the stations comprise:
a first vacuum pressure impregnation tank that is coupled to a first heated storage tank, a first blend tank, a first vacuum source, and delivery lines configured to handle high pH, viscous shear thickening solutions between at least the first vacuum pressure impregnation tank and the heated storage tank;
at least one storage area;
a second vacuum pressure impregnation vessel that is coupled to a second heated storage tank, a second blend tank, a second vacuum source, and delivery lines configured to handle high pH, viscous solutions between at least the first vacuum pressure impregnation tank and the heated storage tank;
at least one CO₂ storage tank with an associated vaporizer and a CO₂ recovery system coupled to at least the first and second vacuum impregnation vessels;
at least one kiln;
a thermal management system comprising:
insulation and cladding on one or more of the vessels, tanks, and lines; and
heat tracing sensors; and
pumps configured to circulate solutions.

18. The plant to perform a lumber vacuum-pressure impregnation process of claim 17, further comprising:
an autoclave configured to handle a siliceous solution pressurized to at least 190 psi.

19. The plant to perform a lumber vacuum-pressure impregnation process of claim 17, further comprising:
a controller configured to track, record, and analyze process variables for sodium silicate solutions, wherein the process variables include one or more of solution temperature, autoclave pressure, amounts of solution utilized, storage tanks temperatures, treatment autoclave temperatures, and duration of each stage of the process.

20. The plant to perform a lumber vacuum-pressure impregnation process of claim 19, wherein the controller is a programmable logic controller.
